(19) United States
(12) Patent Application Publication
(10) Pub. No.: US 2026/0037702 A1
(43) Pub. Date: Feb. 5, 2026

(54) Method for GNN-BASED Automatic Bay Zoning

(71) Applicant: XIAMEN UNIVERSITY, Xiamen (CN)

(72) Inventors: Shaobin LI, Xiamen (CN); Zhehan HUANG, Xiamen (CN); Nengwang CHEN, Xiamen (CN); Zhongyao LIANG, Xiamen (CN)

(73) Assignee: XIAMEN UNIVERSITY, Xiamen (CN)

(21) Appl. No.: 19/026,461

(22) Filed: Jan. 17, 2025

(30) Foreign Application Priority Data
Jul. 30, 2024 (CN) 202411032684.3

(51) Int. Cl. G06F 30/28; G06F 30/27

(52) U.S. Cl. CPC G06F 30/28; G06F 30/27; G01V 20/00; G06F 18/29; G06N 3/04; G06N 3/0464; G06N 7/01; G06V 10/761; G06V 10/7635

(57) ABSTRACT

A method for GNN-based automatic bay zoning includes the following steps: S1, using a modified data packet to convert an output file of the hydrodynamic model into a .nc file that can be read by Python software; S2, reading the converted .nc file and performing data preprocessing; S3, using a tsfresh data packet to extract time series feature values of different features; S4, using a Delaunay triangulation algorithm and a four-way matrix or an eight-way matrix to determine spatial connectivity, and constructing an adjacency matrix; S5, constructing a convolutional GNN to learn bay characteristics and spatial connectivity; S6, using a Louvain algorithm or a Spectral Clustering algorithm to perform unsupervised classification of bay; S7, post-processing broken edges of bay zoning; and S8, outputting zoning results in the form of a .shp file to realize the automatic bay zoning.

### CROSS REFERENCE TO RELATED APPLICATION

This application is based upon and claims priority to Chinese Patent Application No. 202411032684.3, filed on Jul. 30, 2024, the entire content of which is incorporated herein by reference.

### TECHNICAL FIELD

The present disclosure relates to the technical field of hydrodynamics-water quality modeling, and particularly relates to a method for graph neural network (GNN)-based automatic bay zoning.

### BACKGROUND

As an intersection between an ocean and land, a bay plays a key role in maintaining an ecological balance and promoting marine resource development and environmental protection. Further, the bay is also a hotspot region of economic activities, and has a far-reaching influence on development of industries such as marine aquaculture and shipping. Therefore, it is particularly urgent to carry out researches on bay hydrodynamics-water quality modeling, deeply analyze causes of bay water pollution and eutrophication, and provide a scientific basis for environmental governance and decision-making about bays through simulation and prediction.

Many methods such as Delft3D and MIKE have been widely used in the field of bay nutrient simulation. However, use of these methods usually incurs high computational costs due to pursuit of a high spatiotemporal resolution, making it challenging to optimize management decisions. In view of this, a partitioned box model has become a feasible nutrient simulation solution due to a low cost, and is consistent with a bay zoning management mode. However, traditional bay zoning is mainly based on administrative division and topography, which hardly ensures that hydrodynamic conditions of each zone remain consistent in time series, and will affect accuracy of nutrient simulation through the partitioned box model.

### SUMMARY

An objective of the present disclosure is to provide a method for GNN-based automatic bay zoning. The method is flexible and easy to use, and can be applied to bays that have been modeled based on a hydrodynamic model. According to the method, a bay can be divided into a small number of zones with relatively uniform internal hydrodynamic conditions, which facilitates subsequent modeling and analysis of bay nutrients through a box model.

In order to achieve the above objective, the present disclosure adopts a technical solution as follows:

A method for GNN-based automatic bay zoning, including the following steps:
S1, using a modified data packet to convert an output file of the hydrodynamic model into a .nc file that can be read by Python software;
S2, reading the converted .nc file and performing data preprocessing;
S3, using a tsfresh data packet to extract time series feature values of different features;
S4, using a Delaunay triangulation algorithm and a four-way matrix or an eight-way matrix to determine spatial connectivity, and constructing an adjacency matrix;
S5, constructing a convolutional GNN to learn bay characteristics and spatial connectivity;
the convolutional GNN in S5 is constructed using an existing GCN framework in a pytorch software data packet, where a loss function is calculated by distinguishing positive and negative samples and summing structural losses thereof, with a specific calculation formula as follows:

$$\begin{matrix}positive\_loss = \frac{{\sum }_{( i , j ) ∈ positive\_pairs} {‖ embeddings [ i ] - embeddings [ j ] ‖}^{2}}{\vert positive\_pairs \vert} \\ negative\_loss = \frac{{\sum }_{( i , j ) ∈ negative\_pairs} max {( 0 , margin - ‖ embeddings [ i ] - embeddings [ j ] ‖ )}^{2}}{\vert negative\_pairs \vert} \\ total\_loss = positive\_loss + negative\_loss\end{matrix}$$

where positive_loss represents a positive sample loss; (i, j) represents a grid located at an i^{th} row and a j^{th} column; embeddings represents a feature embedding matrix of nodes; embeddings[i] represents an embedding vector of an i^{th} node; embeddings[j] represents an embedding vector of a j^{th} node; positive pairs represents a set of all positive sample pairs in a graph; negative_loss represents a negative sample loss; negative pairs represents a set of all negative sample pairs in the graph; margin is a hyperparameter used to define an interval between negative sample pairs; and total_loss represents a total loss;
S6, using a Louvain algorithm or a Spectral Clustering algorithm to perform unsupervised classification of bay;
S7, post-processing broken edges of bay zoning through a neighboring grid consistency method; and
S8, based on the convolutional GNN, outputting zoning results in the form of a .shp file to realize the automatic bay zoning.

Preferably, the data packet in the S1 is trim2nc, which was originally compiled and run based on matlab software, but now is run through the Python software after modification, and data conversion codes for grid positions, flow velocities, temperatures, and densities are added; and the output file of the hydrodynamic model is in a .dat format, and the hydrodynamic model is one of a Delft3D model and a MIKE model.

Preferably, a specific process of the S2 includes:
S21, data reading: using the Python software to read the converted .nc file, and obtaining data of each grid of the bay including a temperature, a salinity, a friction coefficient, a flow velocity, a topography and a density;
S22, time series data filling: expanding the data including the temperature, the salinity, the friction coefficient, the flow velocity, the topography and the density into time series data respectively, and matching cross-sectional data with remaining time series data, where the friction coefficient and the topography belong to the cross-sectional data, and the temperature, the salinity, the flow velocity and the density belong to the remaining time series data;
S23, land-sea identification: constructing a land-sea mask matrix according to grid data output by the hydrodynamic model, where in the mask matrix, a land grid is encoded as 0 and a sea grid is encoded as 1;
S24, mask extraction: based on results of the land-sea identification, performing the mask extraction of a bay zone through the land-sea mask matrix; and
S25, neighboring interpolation filling: filling a missing value of the flow velocity after averaging through a surrounding 3×3 grid.

Preferably, in the S3, the tsfresh data packet in the Python software is used to extract all time series eigenvalues in batches, and the time series eigenvalues include absolute energy, an absolute value of continuous change, unit root test results, and a centroid of a Fourier transform spectrum.

Preferably, in the S4, the spatial connectivity of the sea grid is determined; four-way connectivity indicates that each grid is connected to four adjacent grids (i.e., upper, lower, left, and right grids), eight-way connectivity indicates that each grid is connected to eight adjacent grids (i.e., upper, lower, left, right, and diagonal grids), and a corresponding position in the adjacency matrix is marked as 1 to indicate the spatial connectivity; the Delaunay triangulation algorithm constructs a large triangle containing all grids, then repeatedly inserts central points of internal grids to split the triangle, makes a small triangle meet Delaunay triangulation conditions through edge flipping, finally removes an external triangle, and also marks grids corresponding to three vertices of the split small triangle as 1 at corresponding positions of the adjacency matrix to indicate the spatial connectivity.

Preferably, in the S6, the learned convolutional GNN is used for the unsupervised classification, where the number of clusters of the Louvain algorithm is not optional, and modularity is optimized based on a greedy algorithm, where a calculation formula of the modularity is as follows:

$$Q = \frac{1}{2 m} {\sum }_{i , j} [ {A}_{i , j} - \frac{{k}_{i} {k}_{j}}{2 m} ] δ ( {c}_{i} , {c}_{j} )$$

where Q represents the modularity; m represents a sum of weights of all edges in the GNN; A_{i,j} represents an adjacency matrix of the GNN; kᵢ represents a degree of the i^{th} node; kⱼ represents a degree of the j^{th} node; cᵢ represents a community to which the i^{th} node belongs; cⱼ represents a community to which the j^{th} node belongs; δ(cᵢ, cⱼ) is an indicator function, and when cᵢ=cⱼ, δ(cᵢ, cⱼ) is 1, otherwise δ(cᵢ, cⱼ) is 0;
the number of clusters of the Spectral Clustering algorithm is manually specified, and calculation thereof requires construction of a similarity matrix, a degree matrix, and a Laplacian matrix, with specific calculation formulas as follows:

$$\begin{matrix}{A}_{i , j} = exp ( - \frac{{‖ {x}_{i} - {x}_{j} ‖}^{2}}{2 σ} ) \\ {D}_{i , i} = {\sum }_{j} {A}_{i , j} \\ L = D - A\end{matrix}$$

where A is the similarity matrix; D is the degree matrix; L is the Laplacian matrix; ∥xᵢ−xⱼ∥² represents a square of a Euclidean distance between the i^{th} node and the j^{th} node; σ is a bandwidth parameter of a Gaussian kernel; and D_{i,j} represents an element in the degree matrix.

Preferably, a specific process of the S7 includes: using the neighboring grid consistency method to gradually determine whether the largest number of grids among 3×3, 5×5 to 11×11 grids surrounding central grids thereof are consistent with the central grids in category; in case of consistency, stopping executing the current algorithm, otherwise modifying the category of the central grid until all grids meet this criterion, where the neighboring grid consistency method is used to solve the problem of more fragmented grid classifications.

Preferably, in the S8, different zones are encoded as different digital numbers and input as field information into a newly created field class of the .shp file output by the hydrodynamic model, thereby realizing a visual presentation of zoning information.

Based on the above technical solution, the present disclosure has the following beneficial effects: the present disclosure, by utilizing the GNN technology, is capable of effectively capturing complex geographical and hydrodynamic features and improving accuracy and efficiency of zoning; this method is not only applicable to new bay zones, but also can be easily applied to bays that have been modeled through the hydrodynamic model, such that this method can be seamlessly integrated into an existing water environment management framework without need to significantly modify or redesign an existing model; and the present disclosure, by dividing the bay into zones with relatively uniform internal hydrodynamic conditions, can simplify the subsequent modeling and analysis of bay nutrients through the box model.

### BRIEF DESCRIPTION OF THE DRAWINGS

FIG. 1 is a flowchart of the present disclosure.

### DETAILED DESCRIPTION OF THE EMBODIMENTS

To make the objectives, technical solutions and advantages of the present disclosure clearer, the present disclosure will be described in further detail below in conjunction with the examples. It should be understood that specific examples described herein are merely used to explain the present disclosure, and are not used to limit the present disclosure.

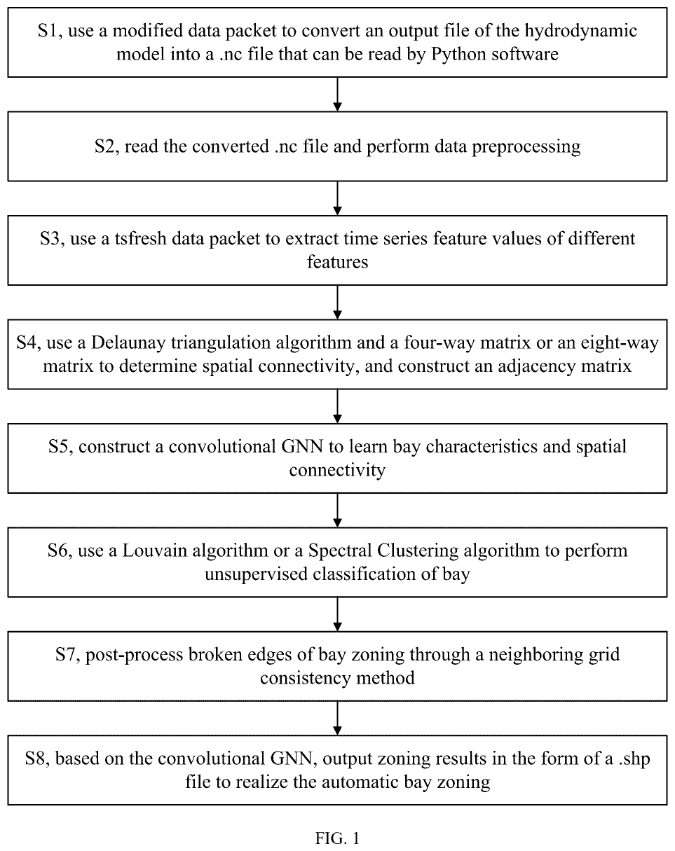

As illustrated in FIG. 1, a method for GNN-based automatic bay zoning includes the following steps:

S1, use a modified data packet to convert an output file of a hydrodynamic model into a .nc file that can be read by Python software;

the data packet in the S1 is trim2nc, which was originally compiled and run based on matlab software, but now is run through the Python software after modification, and data conversion codes for grid positions, flow velocities, temperatures, and densities are added; and the output file of the hydrodynamic model is in a .dat format, and the hydrodynamic model is one of a Delft3D model and a MIKE model.
S2, read the converted .nc file and perform data preprocessing;
a specific process of the S2 includes:
S21, data reading: use the Python software to read the converted .nc file, and obtain data of each grid of the bay including a temperature, a salinity, a friction coefficient, a flow velocity, a topography and a density;
S22, time series data filling: expand the data including the temperature, the salinity, the friction coefficient, the flow velocity, the topography and the density into time series data respectively, and match cross-sectional data with remaining time series data, where the friction coefficient and the topography belong to the cross-sectional data, and the temperature, the salinity, the flow velocity and the density belong to the remaining time series data;
S23, land-sea identification: construct a land-sea mask matrix according to grid data output by the hydrodynamic model, where in the mask matrix, a land grid is encoded as 0 and a sea grid is encoded as 1;
S24, mask extraction: based on results of the land-sea identification, perform the mask extraction of a bay zone through the land-sea mask matrix; and
S25, neighboring interpolation filling: fill a missing value of the flow velocity after averaging through a surrounding 3×3 grid.
S3, use a tsfresh data packet to extract time series feature values of different features;
in the S3, the tsfresh data packet in the Python software is used to extract all time series eigenvalues in batches, and the time series eigenvalues include absolute energy, an absolute value of continuous change, unit root test results, and a centroid of a Fourier transform spectrum;
S4, use a Delaunay triangulation algorithm and a four-way matrix or an eight-way matrix to determine spatial connectivity, and construct an adjacency matrix;
in the S4, the spatial connectivity of the sea grid is determined; four-way connectivity indicates that each grid is connected to four adjacent grids (i.e., upper, lower, left, and right grids), eight-way connectivity indicates that each grid is connected to eight adjacent grids (i.e., upper, lower, left, right, and diagonal grids), and a corresponding position in the adjacency matrix is marked as 1 to indicate the spatial connectivity; the Delaunay triangulation algorithm constructs a large triangle containing all grids, then repeatedly inserts central points of internal grids to split the triangle, makes a small triangle meet Delaunay triangulation conditions through edge flipping, finally removes an external triangle, and also marks grids corresponding to three vertices of the split small triangle as 1 at corresponding positions of the adjacency matrix to indicate the spatial connectivity.
S5, construct a convolutional GNN to learn bay characteristics and spatial connectivity;
the convolutional GNN in S5 is constructed using an existing graph convolutional network (GCN) framework in a pytorch software data packet, where a loss function is calculated by distinguishing positive and negative samples and summing structural losses thereof, with a specific calculation formula as follows:

$$\begin{matrix}positive\_loss = \frac{{\sum }_{( i , j ) ∈ positive\_pairs} {‖ embeddings [ i ] - embeddings [ j ] ‖}^{2}}{\vert positive\_pairs \vert} \\ negative\_loss = \frac{{\sum }_{( i , j ) ∈ negative\_pairs} max {( 0 , margin - ‖ embeddings [ i ] - embeddings [ j ] ‖ )}^{2}}{\vert negative\_pairs \vert} \\ total\_loss = positive\_loss + negative\_loss\end{matrix}$$

where positive_loss represents a positive sample loss; (i, j) represents a grid located at an i^{th} row and a j^{th} column; embeddings represents a feature embedding matrix of nodes; embeddings[i] represents an embedding vector of an i^{th} node; embeddings[j] represents an embedding vector of a j^{th} node; positive pairs represents a set of all positive sample pairs in a graph; negative_loss represents a negative sample loss; negative pairs represents a set of all negative sample pairs in the graph; margin is a hyperparameter used to define an interval between negative sample pairs; and total_loss represents a total loss;
S6, use a Louvain algorithm or a Spectral Clustering algorithm to perform unsupervised classification of bay;
in the S6, the learned convolutional GNN is used for the unsupervised classification, where the number of clusters of the Louvain algorithm is not optional, and modularity is optimized based on a greedy algorithm, where a calculation formula of the modularity is as follows:

$$Q = \frac{1}{2 m} {\sum }_{i , j} [ {A}_{i , j} - \frac{{k}_{i} {k}_{j}}{2 m} ] δ ( {c}_{i} , {c}_{j} )$$

where Q represents the modularity; m represents a sum of weights of all edges in the network; A_{i,j} represents an adjacency matrix of the network; kᵢ represents a degree of the i^{th} node; kⱼ represents a degree of the j^{th} node; c; represents a community to which the i^{th} node belongs; cⱼ represents a community to which the j^{th} node belongs; δ(cᵢ, cᵢ) is an indicator function, and when cᵢ=cⱼ, δ(cᵢ, cⱼ) is 1, otherwise δ(cᵢ, cⱼ) is 0;
the number of clusters of the Spectral Clustering algorithm is manually specified, and calculation thereof requires construction of a similarity matrix, a degree matrix, and a Laplacian matrix, with specific calculation formulas as follows:

$$\begin{matrix}{A}_{i , j} = exp ( - \frac{{‖ {x}_{i} - {x}_{j} ‖}^{2}}{2 σ} ) \\ {D}_{i , i} = {\sum }_{j} {A}_{i , j} \\ L = D - A\end{matrix}$$

where A is the similarity matrix; D is the degree matrix; L is the Laplacian matrix; ∥xᵢ−xⱼ∥² represents a square of a Euclidean distance between the i^{th} node and the j^{th} node; is a bandwidth parameter of a Gaussian kernel; and D_{i,j} represents an element in the degree matrix;
S7, post-process broken edges of bay zoning through a neighboring grid consistency method; and
a specific process of the S7 includes: use the neighboring grid consistency method to gradually determine whether the largest number of grids among 3×3, 5×5 to 11×11 grids surrounding central grids thereof are consistent with the central grids in category; in case of consistency, stop executing the current algorithm, otherwise modify the category of the central grid until all grids meet this criterion, where the neighboring grid consistency method is used to solve the problem of more fragmented grid classifications;
S8, based on the convolutional GNN, output zoning results in the form of a .shp file to realize the automatic bay zoning; and
in the S8, different zones are encoded as different digital numbers and input as field information into a newly created field class of the .shp file output by the hydrodynamic model realizing a visual presentation of zoning information.

The foregoing descriptions are merely preferred specific embodiments of the present disclosure, and are not intended to limit the protection scope of the present disclosure. Any equivalent substitutions or changes made by a person skilled in the art easily within the technical scope disclosed in the present disclosure shall fall within the protection scope of the present disclosure. Therefore, the protection scope of the present disclosure should be subject to the protection scope of the claims.

What is claimed is:

1. A method for GNN-based automatic bay zoning, comprising the following steps:
S1, using a modified data packet to convert an output file of the hydrodynamic model into a .nc file that can be read by Python software;
the data packet in the S1 is trim2nc, which was originally compiled and run based on matlab software, but now is run through the Python software after modification, and data conversion codes for grid positions, flow velocities, temperatures, and densities are added; and the output file of the hydrodynamic model is in a .dat format, and the hydrodynamic model is one of a Delft3D model and a MIKE model;
S2, reading the converted .nc file and performing data preprocessing;
a specific process of the S2 comprises:
S21, data reading: using the Python software to read the converted .nc file, and obtaining data of each grid of the bay comprising a temperature, a salinity, a friction coefficient, a flow velocity, a topography and a density;
S22, time series data filling: expanding the data comprising the temperature, the salinity, the friction coefficient, the flow velocity, the topography and the density into time series data respectively, and matching cross-sectional data with remaining time series data, wherein the friction coefficient and the topography belong to the cross-sectional data, and the temperature, the salinity, the flow velocity and the density belong to the remaining time series data;
S23, land-sea identification: constructing a land-sea mask matrix according to grid data output by the hydrodynamic model, wherein in the mask matrix, a land grid is encoded as 0 and a sea grid is encoded as 1;
S24, mask extraction: based on results of the land-sea identification, performing the mask extraction of a bay zone through the land-sea mask matrix; and
S25, neighboring interpolation filling: filling a missing value of the flow velocity after averaging through a surrounding 3×3 grid;
S3, using a tsfresh data package to extract time series feature values of different features;
in the S3, the tsfresh data packet in the Python software is used to extract all time series eigenvalues in batches, and the time series eigenvalues include absolute energy, an absolute value of continuous change, unit root test results, and a centroid of a Fourier transform spectrum;
S4, using a Delaunay triangulation algorithm and a four-way matrix or an eight-way matrix to determine spatial connectivity, and constructing an adjacency matrix;
S5, constructing a convolutional GNN to learn bay characteristics and spatial connectivity;
the convolutional GNN in S5 is constructed using an existing graph convolutional network (GCN) framework in a pytorch software data packet, wherein a loss function is calculated by distinguishing positive and negative samples and summing structural losses thereof, with a specific calculation formula as follows:
$$\begin{matrix}positive\_loss = \frac{{\sum }_{( i , j ) ∈ positive\_pairs} {‖ embeddings [ i ] - embeddings [ j ] ‖}^{2}}{\vert positive\_pairs \vert} \\ negative\_loss = \frac{{\sum }_{( i , j ) ∈ negative\_pairs} max {( 0 , margin - ‖ embeddings [ i ] - embeddings [ j ] ‖ )}^{2}}{\vert negative\_pairs \vert} \\ total\_loss = positive\_loss + negative\_loss\end{matrix}$$
in the formula, positive_loss represents a positive sample loss; (i, j)_represents a grid located at an i^{th} row and a j^{th} column; embeddings represents a feature embedding matrix of nodes; embeddings[i] represents an embedding vector of an i^{th} node; embeddings[j] represents an embedding vector of a j^{th} node; positive_pairs represents a set of all positive sample pairs in a graph; negative_loss represents a negative sample loss; negative pairs represents a set of all negative sample pairs in the graph; margin is a hyperparameter used to define an interval between negative sample pairs; and total_loss represents a total loss;
S6, using a Louvain algorithm or a Spectral Clustering algorithm to perform unsupervised classification of bay;
S7, post-processing broken edges of bay zoning through a neighboring grid consistency method; and
S8, based on the convolutional GNN, outputting zoning results in the form of a .shp file to realize the automatic bay zoning.

2. The method for GNN-based automatic bay zoning according to claim 1, wherein in the S4, the spatial connectivity of the sea grid is determined; four-way connectivity indicates that each grid is connected to four adjacent grids, eight-way connectivity indicates that each grid is connected to eight adjacent grids (i.e., upper, lower, left, right, and diagonal grids), and a corresponding position in the adjacency matrix is marked as 1 to indicate the spatial connectivity; the Delaunay triangulation algorithm constructs a large triangle containing all grids, then repeatedly inserts central points of internal grids to split the triangle, makes a small triangle meet Delaunay triangulation conditions through edge flipping, finally removes an external triangle, and also marks grids corresponding to three vertices of the split small triangle as 1 at corresponding positions of the adjacency matrix to indicate the spatial connectivity.

3. The method for GNN-based automatic bay zoning according to claim 1, wherein in the S6, the learned convolutional GNN is used for the unsupervised classification, wherein the number of clusters of the Louvain algorithm is not optional, and modularity is optimized based on a greedy algorithm, wherein a calculation formula of the modularity is as follows:
$$Q = \frac{1}{2 m} {\sum }_{i , j} [ {A}_{i , j} - \frac{{k}_{i} {k}_{j}}{2 m} ] δ ( {c}_{i} , {c}_{j} )$$
in the formula, Q represents the modularity; m represents a sum of weights of all edges in the GNN; A_{i,j} represents an adjacency matrix of the GNN; kᵢ represents a degree of the i^{th} node; kⱼ represents a degree of the j^{th} node; cᵢ represents a community to which the i^{th} node belongs; cⱼ represents a community to which the j^{th} node belongs; δ(cᵢ, cⱼ) is an indicator function, and when cᵢ=cⱼ, δ(cᵢ, cⱼ) is 1, otherwise δ(cᵢ, cⱼ) is 0;
the number of clusters of the Spectral Clustering algorithm is manually specified, and calculation thereof requires construction of a similarity matrix, a degree matrix, and a Laplacian matrix, with specific calculation formulas as follows:
$$\begin{matrix}{A}_{i , j} = exp ( - \frac{{‖ {x}_{i} - {x}_{j} ‖}^{2}}{2 σ} ) \\ {D}_{i , i} = {\sum }_{j} {A}_{i , j} \\ L = D - A\end{matrix}$$
in the formula, A is the similarity matrix; D is the degree matrix; L is the Laplacian matrix; ∥xᵢ−xⱼ∥² represents a square of a Euclidean distance between the i^{th} node and the j^{th} node; σ is a bandwidth parameter of a Gaussian kernel; and D_{i,j} represents an element in the degree matrix.

4. The method for GNN-based automatic bay zoning according to claim 1, wherein a specific process of the S7 comprises: using the neighboring grid consistency method to gradually determine whether the largest number of grids among 3×3, 5×5 to 11×11 grids surrounding central grids thereof are consistent with the central grids in category; in case of consistency, stopping executing the current algorithm, otherwise modifying the category of the central grid until all grids meet this criterion.

5. The method for GNN-based automatic bay zoning according to claim 1, wherein in the S8, different zones are encoded as different digital numbers and input as field information into a newly created field class of the .shp file output by the hydrodynamic model, thereby realizing a visual presentation of zoning information.
